(19) United States
(12) Patent Application Publication
(10) Pub. No.: US 2024/0192500 A1
(43) Pub. Date: Jun. 13, 2024

(54) OPTICAL SYSTEM FOR A RETINAL SCAN DISPLAY AND METHOD FOR PROJECTING IMAGE CONTENTS ONTO A RETINA

(71) Applicant: Robert Bosch GmbH, Stuttgart (DE)

(72) Inventors: Nikolai Suchkov, Stuttgart (DE); Andreas Petersen, Eningen (DE); Anna-Katharina Friedel, Wannweil (DE); Hendrik Specht, Pliezhausen (DE); Johannes Hofmann, Tuebingen (DE); Mazyar Sabbar, Tuebingen (DE); Tadiyos Alemayehu, Pfullingen (DE)

(21) Appl. No.: 18/552,706

(22) PCT Filed: May 23, 2022
(86) PCT No.: PCT/EP2022/063852

§ 371 Date: Sep. 27, 2023

(30) Foreign Application Priority Data
Jun. 29, 2021 (DE) 10 2021 206 753.0
Jul. 28, 2021 (DE) 10 2021 208 157.6

(51) Int. Cl. G02B 27/01; G02B 5/30; G02B 26/10; G02B 27/00; G09G 3/00

(52) U.S. Cl. CPC G02B 27/0172; G02B 5/30; G02B 26/101; G02B 27/0093; G09G 3/002; G02B 2027/0174; G02B 2027/0178

(57) ABSTRACT

An optical system for a virtual retinal display. The optical system includes: an image source providing image content as image data; an image processing device for the image data; a projector unit generating at least one light beam and including a drivable deflection device for the at least one light beam for scanning projection of the image content; a first deflection unit onto which the image content is projectable and configured to direct the projected image content onto a user's eye; a second deflection unit arranged between the projector unit and first deflection unit configured to deflect the light beam via a first imaging path at a first point in time and via a second imaging path at a second point in time subsequent to the first point in time onto at least one projection region of the first deflection unit; and an optical replication component.

### BACKGROUND INFORMATION

Data glasses (smart glasses) with retinal scan displays are described in the related art.

### SUMMARY

According to the present invention, an optical system is provided for a virtual retinal display (retinal scan display). according to an example embodiment of the present invention, the optical system includes:
a. an image source which provides image content in the form of image data,
b. an image processing device for the image data,
c. a projector unit with a time-modulable light source for generating at least one light beam and with a drivable deflection device for the at least one light beam for scanning projection of the image content,
d. a first deflection unit onto which the image content is projectable and which is set up to direct the projected image content onto a (user's) eye,
e. a second deflection unit arranged between the projector unit and first deflection unit, which second deflection unit is set up to deflect the light beam, in particular the entire light beam, via a first imaging path at a first point in time and via a second imaging path at a second point in time subsequent to the first point in time onto at least one projection region of the first deflection unit, and
f. an optical replication component which is arranged in the at least one projection region of the deflection unit and is set up to replicate the projected image content and to direct it in spatially offset manner onto the user's eye, such that a plurality of exit pupils (eyeboxes A, A′, B, B′) which are arranged spatially offset from one another and include the image content are generated.

The configuration according to the present invention of the optical system ensures elevated efficiency of the optical system since the light beam or beam pencil is not split but merely deflected and thus substantially the entire laser power can be used for each imaging path. Moreover, deflection of the light beam or beam pencil in temporal succession via the different imaging paths means that the spatial resolution and/or field of view of the original image content is at least substantially obtained.

A “virtual retinal display” should in particular be taken to mean a retinal scan display or light-field display in which the image content is sequentially scanned by deflection of at least one light beam, in particular a laser beam from at least one time-modulated light source, such as for example one or more laser diodes, and directly imaged onto the retina of the user's eye by optical elements. The image source in particular takes the form of an electronic image source, for example a graphics output, in particular a(n integrated) graphics card, of a computer or processor or the like. The image source may for example be an integral part of the image processing device of the optical system. Alternatively, the image source may be separate from the image processing device and transmit image data to the image processing device of the optical system. The image data in particular take the form of color image data, for example RGB image data. In particular, the image data may take the form of still or moving images, for example videos. The image processing device is preferably provided to modify, in particular distort, copy, warp, offset, scale or the like, the image data of the image source. The image processing device is preferably provided to generate copies of the image content which are in particular modified, for example distorted, warped, offset and/or scaled.

According to an example embodiment of the present invention, the projector unit is in particular set up to emit the image content from the image data in the form of scanned and/or rasterized light beams. The projector unit in particular comprises a deflection device, preferably a MEMS mirror (micromirror actuator), at least for controlled deflection of the at least one light beam of the light source of the projector unit.

Alternatively or additionally, the deflection device comprises at least one switchable diffractive optical element in the form of a phase and/or intensity modulator, which may for example be embodied as a spatial light modulator (SLM) of reflective construction, for example of DMD or LCoS construction, or of transmissive construction, for example as an LCD. In particular, the time-modulable light source is analog modulated, an alternative TTL modulation also, for example, not being ruled out. The first deflection unit in particular comprises an arrangement of optical elements, for example diffractive, reflective, refractive and/or holographic optical elements. However, the first deflection unit preferably always comprises at least one holographic optical element. The first deflection unit is at least in part integrated into a lens of a pair of data glasses. The first deflection unit is in particular provided to deflect only a portion of the intensity of the projected image content onto the user's eye. At least one further portion of the intensity of the projected image content passes through the first deflection unit. The first deflection unit appears to a user to be substantially transparent at least from a perpendicular gaze direction. In particular, the first deflection unit forms a projection region. In particular, the projection region forms an area within which a light beam is diverted/deflected toward the user's eye, in particular toward an eye pupil area of the optical system, when it impinges on the deflection unit. “Provided” and/or “set up” should be understood to mean in particular specifically programmed, designed and/or equipped. Where an item is provided and/or set up for a specific function, this should in particular be understood to mean that the item fulfills and/or performs this specific function in at least one application state and/or operating state.

According to an example embodiment of the present invention, a second deflection unit is preferably arranged in a beam path of the scanned light beam between the deflection device of the projector unit and the first deflection unit. The different imaging paths at the first and second points in time are in particular taken to mean that the light beam or beam pencil is in each case deflected at a different angle onto the projection region and/or onto different subregions of the projection region. Each imaging path is associated with its own exit pupil. The second deflection unit is in particular configured to project the, in particular complete, image content in the form of the light beam onto the at least one projection region of the first deflection unit via the first imaging path at the first point in time and via the second imaging path at a second point in time subsequent to the first point in time.

According to an example embodiment of the present invention, the second deflection unit preferably has at least one first switchable transmissive holographic optical layer which in particular takes the form of a first switchable transmission HOE. As a function of their switching state, such switchable HOEs take the form of a deflection element or alternatively of a passive element which transmits the incident light beam without deflection. The second deflection unit additionally has a second transmissive holographic optical layer. The first switchable holographic optical layer is configured to deflect the incident light beam at the first point in time in a first or at the second point in time in a second deflection direction. This deflection in particular proceeds as a function of the respective switching state of the first switchable holographic optical layer. The second deflection unit preferably additionally has at least one third switchable holographic optical layer which is configured to deflect the incident light beam in a third deflection direction. The first switchable holographic optical layer and the third switchable holographic optical layer are preferably arranged stacked on one another. The second transmissive holographic optical layer is configured to diffract the light beam arriving from the first switchable holographic optical layer toward the projection region. The second transmissive holographic optical layer is not switchable. The second transmissive holographic optical layer preferably has at least two holographic deflection functions as a function of the angle of incidence of the incident light beam. If the light beam includes different wavelengths, the second transmissive holographic optical layer preferably additionally has at least two holographic deflection functions as a function of the different wavelengths of the incident light beam. Alternatively, at least one additional fourth transmissive holographic optical layer is preferably also provided which has a different holographic function compared to the second transmissive holographic optical layer. The second and fourth transmissive holographic optical layers are preferably arranged stacked on one another.

According to an example embodiment of the present invention, the second deflection unit preferably has a first deflection component. The first deflection component here has a first switchable λ/2 waveplate and a first optical polarization grating. The second deflection unit preferably also has in this connection a second deflection component. The second deflection component has a second static λ/2 waveplate and a second optical polarization grating. The first deflection component preferably takes the form of a first deflection stack and the second deflection component that of a second deflection stack. Alternatively, the first deflection component and the second deflection component are integrated into a common deflection stack. The first switchable λ/2 waveplate is here configured to alter or maintain a polarization state, in particular the helicity, of an, in particular incident, circularly polarized light beam. The linearly polarized light (emitted by the light source) can be converted into circularly polarized light for example by using a linear polarizer and a λ/4 waveplate. The switchable λ/2 waveplate is in particular configured to adjust the helicity of circularly polarized light as a function of the operating state of the switchable λ/2 waveplate. If such a switchable λ/2 waveplate is switched off, i.e. at a phase delay of zero, the helicity of the light remains unchanged. If the controllable λ/2 waveplate is switched on, i.e. if a phase delay λ/2 is produced, the helicity of the circularly polarized light is reversed. Modulation by the λ/2 waveplate therefore allows the light to be deflected into different diffraction orders and thus also enables selection between the different imaging paths. The first optical polarization grating is configured to deflect, in particular diffract, as a function of the polarization state, the circularly polarized light beam arriving from the switchable λ/2 waveplate in a first deflection direction, in particular at the first point in time, or in a second deflection direction, in particular at the second point in time. In plan view, the light beam is thus deflected to the right or left. The first deflection direction is oriented mirror-inversely to the second deflection direction. The first optical polarization grating accordingly implements the selection between the first or second imaging path previously specified by way of the switchable λ/2 waveplate. The second static λ/2 waveplate is in turn configured to alter the polarization state of the circularly polarized light beam arriving from the first optical polarization grating. In both cases, the second optical polarization grating is then configured to deflect, in particular diffract, the light beam arriving from the second static λ/2 waveplate toward the projection region. The light beam thus propagates with a slight angular and strong spatial offset compared to the light beam irradiated into the second optical deflection unit, whereby a corresponding offset of the eyeboxes on the exit pupil plane is achieved. Compared to the related art, the second deflection unit can be embodied compactly and in weight-saving manner. Any number of further deflection components may preferably be provided in order to produce further imaging paths and thus more exit pupils. The first and/or second polarized gratings is/are preferably mounted rotatably, in particular about an axis of rotation. The axis of rotation is in particular taken to mean the central propagation axis of the light beam or beam pencil. This gives rise to the possibility of continuously positioning the exit pupils.

Alternatively, according to an example embodiment of the present invention, the second deflection unit has a third polarization grating, a fourth polarization grating and a third static λ/2 waveplate. The third polarization grating is configured to deflect or diffract an, in particular incident, circularly polarized light beam in a third deflection direction. The third static λ/2 waveplate is configured to alter a polarization state, in particular the helicity, of the light beam deflected by way of the third polarization grating. The fourth polarization grating is in turn configured to deflect or diffract the light beam arriving from the third λ/2 waveplate toward the projection region. The second deflection unit is here rotatably mounted in particular about the central propagation axis of at the least one light beam as the axis of rotation, such that the light beam emitted from the second deflection unit is deflected onto the at least one projection region of the first deflection unit via the first imaging path at the first point in time and via the second imaging path at the second point in time subsequent to the first point in time. Rotation of the second deflection unit about the corresponding axis of rotation thus enables continuous deflection of the light beam via different imaging paths in a space- and weight-saving manner compared to the related art.

Furthermore alternatively, according to an example embodiment of the present invention, the second deflection unit preferably takes the form of at least one optical prism, in particular glass prism, which is rotatably mounted such that the light beam emitted from the optical prism is deflected onto the at least one projection region of the first deflection unit via the first imaging path at the first point in time and via the second imaging path at the second point in time subsequent to the first point in time. The overall effect here is created by the combined refraction at the air-prism and prism-air interface. The entry and exit faces of the prism may be designed such that, at each angle of incidence, they produce exactly the appropriate lateral displacement and appropriate angular offset on rotation of the prism. This in turn results via the HOE function in laterally offset and controllable exit pupils. A plurality of rotatably mounted optical prisms are preferably provided one behind the other as prism pairs.

According to an example embodiment of the present invention, the image processing device is preferably set up to generate, using the image data from the image source, first subimage data at the first point in time and second subimage data at the second point in time to drive the projector unit. The image processing device is in this connection set up to generate different subimage data for the at least two different imaging paths, such that any distortion of the image content over the respective imaging path is at least partially compensated. In particular, the image processing device is in this connection configured to modify, in particular distort, copy, warp, offset and/or scale, the image data of the image source. The image processing device is preferably provided to generate copies of the image content which are in particular modified, for example distorted, warped, offset and/or scaled. Subimage data are thus taken to mean any image data which have been altered or modified compared to the original image data.

According to an example embodiment of the present invention, the optical replication component is preferably implemented in a multilayer structure with at least one holographically functionalized layer. Advantageously, simple and/or effective optical replication can consequently be achieved. This advantageously means that it is possible to achieve a particularly large number of exit pupils and thus a particularly large effective total eyebox. In particular, a first holographically functionalized layer of the optical replication component generates an (unreplicated) exit pupil set (eyebox set). In particular, a replication of the entire exit pupil set is generated from each further holographically functionalized layer in addition to the first holographically functionalized layer of the optical replication component. In particular, each replication of an exit pupil set involves generating a spatially and/or angularly displaced copy of the original image areas, in particular of the (unreplicated) exit pupil set. In particular, it is also possible for only some of the exit pupils of an (unreplicated) exit pupil set to be replicated by the further holographically functionalized layers in addition to the first holographically functionalized layer of the optical replication component, for example if an areal extent of the two holographically functionalized layers of the optical replication component is different. In particular it is possible for the optical replication component to have at least three or more holographically functionalized layers.

In particular, the holographically functionalized layers are in each case partially reflective and partially transparent. In particular, the optical replication is generated by the same image information, in particular the same light beam, being deflected in each case differently in two respects, for example in two different angular directions, by two holographically functionalized layers of the optical replication component, and thus crossing the eye pupil area at two different points. In particular, the optical replication component is capable of replicating, preferably duplicating, a pattern or an arrangement of exit pupils in the eye pupil area in the vertical direction and/or in the horizontal direction and/or in directions oblique to the vertical direction/horizontal direction.

According to an example embodiment of the present invention, particularly advantageous replication can be achieved if the holographically functionalized layers of the optical replication component take the form of reflective (e.g., reflection holograms) and/or transmissive (e.g., transmission holograms) holographic optical elements (HOEs). In particular, different HOEs can have different optical functions which in particular give rise to different deflection of incident light beams (e.g. by forming reflection holograms which reflect the light beams like concave or convex mirrors). Each HOE is in particular formed from a holographic material, for example from a photopolymer or a silver halide. In particular, at least one holographic optical function is in each case written into the holographic material for each HOE. In particular, at least one holographic optical function comprising a plurality of wavelengths is in each case written into the holographic material for each HOE. In particular, at least one holographic optical function comprising at least one RGB wavelength is in each case written into the holographic material for each HOE.

According to an example embodiment of the present invention, it is moreover provided for the optical replication component to be implemented in a multilayer structure with at least two layers arranged one above the other which have different holographic functions, whereby the plurality of exit pupils which are arranged spatially offset from one another are generated. Advantageous image replication which can in particular be produced inexpensively and/or simply can be achieved in this way. In particular, the layers with different holographic functions are arranged in layers one behind the other in a direction at least substantially perpendicular to the eye pupil area, preferably in an intended gaze direction onto the optical replication component. The optical replication component is in particular integrated into at least one lens of the data glasses. It is possible for the optical replication component to extend over only part of the lens or over the entire lens. In particular, the optical replication component has sufficiently high transparency for it to appear transparent to the wearer of the data glasses. The holographically functionalized layers may differ in size but the holographic material layers preferably overlap completely or nearly completely from the intended gaze direction onto the optical replication component. The holographically functionalized layers may rest directly on one another or be separated from one another by a (transparent) interlayer. It is possible for the holographic functions of the various holographically functionalized layers to be configured to deflect different wavelengths (e.g. one holographic layer per influenced wavelength), but the holographic functions of the various holographically functionalized layers are preferably configured to deflect the same RGB wavelengths.

Alternatively, according to an example embodiment of the present invention, if the optical replication component comprises at least one layer in which at least two different holographic functions are implemented, the different holographic functions being formed in a common plane but in different intermittent zones of the layer, and whereby the plurality of exit pupils which are arranged spatially offset from one another are generated, it is advantageously possible to achieve a particularly thin configuration of the optical replication component. As a result, it is advantageously possible to increase the number of holographic functions per holographic material layer. The spatial extent of HOE substructures of the intermittent zones of the layer of the optical replication component is preferably substantially smaller than a diameter of the light beam, in particular laser beam, of the projection unit. “Substantially smaller” should in this connection be taken to mean at most half as large, preferably at most one third as large, preferably at most one quarter as large and particularly preferably at most one tenth as large. In this manner, it is advantageously ensured that each item of image information arrives in both the exit pupils generated by the different holographic functions. It is possible for layers with different intermittent zones to be combined with full-area holographically functionalized layers.

According to an example embodiment of the present invention, the second deflection unit and the optical replication component are preferably designed such that the exit pupils generated thereby, in particular at different points in time, are arranged substantially in a grid. The distance between in each case two directly and/or diagonally adjacent exit pupils, in particular generated at the different points in time, is here smaller than the smallest anticipated pupil diameter of the user. As a result, it can advantageously be ensured that at least one exit pupil is always visible to the user, in particular overlaps with an entrance pupil of the user's eye, at any point in time of the intended use of the virtual retinal display. As a result, a particularly large effective total eyebox can advantageously be obtained. In particular, various geometric arrangement patterns for arranging the exit pupils within the eye pupil area of the optical system (eyebox patterns) are possible. Possible arrangements include an equidistant parallelogram arrangement (e.g. a symmetrical or asymmetrical quincunx arrangement) or an (e.g. matrix-shaped) square arrangement. A “grid” should in particular be taken to mean a regular pattern distributed over an area.

In contrast with this discrete, fixed positioning of the exit pupils, the above-described rotatably arranged embodiments of the second deflection unit permit continuous positioning of the exit pupils. It is provided in this connection for the second deflection unit and the optical replication component to be designed such that the exit pupils generated at different points in time substantially lie on at least two, in particular identical, geometrically closed curves arranged adjacently on an exit pupil plane. The exit pupils are preferably arranged on two elliptical circular paths. The second deflection unit is for this purpose preferably arranged rotated about the central propagation axis of the beams such that the exit pupils can be offset on an ellipse in a plane orthogonal to the propagation axis. The at least two geometrically closed curves preferably do not overlap but are arranged separately from one another. Alternatively or additionally, the second deflection unit and the optical replication component are designed such that the exit pupils generated at different points in time are substantially arranged within at least two, in particular identical, geometrically closed curves arranged adjacently on an exit pupil plane. The second deflection unit is for this purpose arranged rotatably about an adjustable axis of rotation. Still more possible positions for the exit pupils are thus obtained. The second deflection unit and the optical replication component are preferably designed such that the exit pupils generated by way of the first deflection unit are arranged on and/or within the first of the at least two geometrically closed curves and the generated exit pupils generated by way of the optical replication component are arranged on and/or within the second of the at least two geometrically closed curves. The two geometrically closed curves are preferably arranged relative to one another in such a manner that the minimum distance of the curves from one another is smaller than the smallest anticipated pupil diameter of the user. As a result, it can also be ensured that at least one exit pupil is always visible to the user, in particular overlaps with an entrance pupil of the user's eye, at any point in time of the intended use of the virtual retinal display. The second deflection unit is preferably rotatably mounted in such a manner that the positions of the exit pupils on and/or within the at least two geometrically closed curves are adjustable, in particular steplessly.

According to an example embodiment of the present invention, the second deflection unit and the optical replication component are preferably designed such that each distance between two exit pupils generated on a common imaging path is greater than the greatest anticipated pupil diameter of the user. As a result, the image content can be advantageously reproduced, in particular without perceptible ghosting, on the retina of the user's eye. In particular, a plurality of copies of a reproduction of the image content which are optically identical, but spatially displaced relative to one another in the eye pupil area are never simultaneously visible to the user.

According to an example embodiment of the present invention, an eye tracking device is preferably provided for detecting and/or determining the user's eye status, in particular for detecting and/or determining eye movement, eye movement velocity, pupil position, pupil size, gaze direction, accommodation state and/or fixation distance of the eye. As a result, improved functionality of the virtual retinal display can advantageously be achieved. A particularly user-friendly virtual retinal display may advantageously be achieved which adjusts the reproduced images in a manner imperceptible to the user, such that the user can experience a perceived image which is as uniform as possible. In particular, the eye tracking device takes the form of a component of the virtual retinal display, in particular of the optical system. Detailed configurations of eye trackers are described in the related art, and therefore will not be discussed in any greater detail here. It is possible for the eye tracking device to comprise a monocular or a binocular eye tracking system, at least the binocular eye tracking system in particular being set up to derive a fixation distance from opposing eye movements (vergence). The eye tracking device alternatively or additionally comprises an eye tracking system with a depth sensor for determining a gaze point in the surroundings for determining the fixation distance. The eye tracking device and/or the optical system alternatively or additionally comprises one or more sensors for indirect, in particular context-dependent, determination of a most probable accommodation state of the user's eye, such as for example sensors for determining a head posture, GPS sensors, acceleration sensors, timekeepers and/or brightness sensors or the like. The eye tracking device is preferably at least in part integrated in a component of the data glasses, for example in a frame of the data glasses.

According to an example embodiment of the present invention, the optical system preferably additionally has a control unit which is configured to drive the second deflection unit in such a manner that the light beam is deflected onto at least one projection region of the first deflection unit via the first imaging path at the first point in time and via the second imaging path at the second point in time subsequent to the first point in time. The control unit is preferably configured in this connection to select the first and second points in time in a fixed first sequence, in particular as a function of a duration for generating a respective vertical scan pass or frame. The control unit is accordingly preferably configured to change over from the first imaging path to the second imaging path (and vice versa) when the vertical blanking interval of a respective scan process is reached. The light source is preferably blanked out at the switchover time. The control unit is alternatively preferably configured to select the first and second points in time as a function of a duration for generating a respective horizontal scan pass. The control unit is accordingly preferably configured to change over from the first imaging path to the second imaging path (and vice versa) when the horizontal blanking interval of a respective scan process is reached. A 60 Hz frame rate is in particular used for a scan process. Furthermore alternatively, the first and second points in time are determined stochastically as a function of pupil position. In this connection, the optical system additionally has a memory unit on which are stored the positions associated with a respective imaging path of the exit pupils generated on an imaging path on the exit pupil plane. In other words, the memory unit stores the information which indicates which control signal for the second deflection unit leads to which imaging path and to which position of the exit pupil thus generated. The control unit is configured to drive the second deflection unit in such a manner that the light beam is deflected via the first imaging path at the first point in time and via the second imaging path at the second point in time subsequent to the first point in time as a function of the saved positions of the exit pupils and of the user's eye status such that exactly one exit pupil is generated in the region of the user's pupil. The basis here is in particular the greatest anticipated pupil diameter. Dynamic driving by way of eye tracking thus ensures that an exit pupil is always located in the region of the user's pupil. At the same time, said driving also ensures that there is never, in particular simultaneously, more than one exit pupil in the region of the user's pupil. In the above-described embodiments, the light source is preferably blanked out at the switchover time.

According to an example embodiment of the present invention, when generating the image data, in particular the subimage data, the image processing device is preferably set up to take account of the detected eye status of the user and/or to take account of which imaging path is currently being used in order to compensate fluctuations in the brightness of the perceived image caused thereby. As a result, a maximally constant perceived brightness can advantageously be generated. For example, altering the position and/or size of the pupil of the user's eye changes the participation of the exit pupils which, given an appropriately rapid changeover from the first to the second imaging path, would apparently simultaneously enter the user's eye or would contribute to superimposed reproduction of the image content on the retina of the user's eye. This may result in a variation in perceived brightness (more exit pupils enter the user's eye and are superimposed to form a common reproduction=brighter; fewer exit pupils enter the user's eye and are superimposed to form a common reproduction=darker). In particular, the control unit and/or the image processing device is/are set up to select the individual switchable imaging paths which generate the exit pupils in such a manner that an at least substantially constant number of exit pupils always passes apparently simultaneously through the pupil of the user's eye. Alternatively or additionally, the open- or closed-loop control unit and/or the image processing device may be provided to open- or closed-loop control a global brightness of all exit pupils, in particular of the image content directed via the exit pupils into the user's eye, in accordance with the number of exit pupils apparently simultaneously passing through the pupil. In each case, the total energy requirement can advantageously be reduced.

According to an example embodiment of the present invention, the image processing device is preferably set up, when generating the image data, in particular the subimage data, to take account of and compensate a user's visual impairment and/or defective accommodation. As a result, improved functionality of the virtual retinal display can advantageously be achieved. Use of the virtual retinal display can advantageously be enabled irrespective of visual acuity and/or irrespective of further visual acuity correction devices, such as contact lenses.

It is additionally provided that the optical system comprises a pair of data glasses with a frame and lenses, that the at least one projector unit and the at least one second deflection unit are arranged on the frame and that the at least one first deflection unit with the at least one replication component is arranged in the region of at least one lens, in particular is integrated in at least one lens. In this way, it is possible to achieve an advantageous configuration of the data glasses and/or advantageous integration of the virtual retinal display. In particular, the data glasses may also comprise more than one projector unit, more than one second deflection unit, more than one first deflection unit and/or more than one replication component, for example in each case one for each lens of the data glasses.

According to an example embodiment of the present invention, it is alternatively provided for the image source to be arranged together with the image processing device in an external apparatus and for the image data, in particular the subimage data, to be transmitted from the external apparatus to the projector unit of the data glasses. In this way, it is possible to achieve an advantageous configuration of the data glasses, which inter alia is particularly light in weight and/or can be manufactured particularly inexpensively. In particular, the data glasses have a wireless or wired communication device which is at least set up to receive the image data, in particular the subimage data, from the external apparatus. The external apparatus in particular takes the form of an apparatus external to the data glasses. The external apparatus may for example take the form of a smartphone, a tablet, a personal computer (e.g. a notebook) or the like.

The present invention also provides a method for projecting image content onto a user's retina with the assistance of an optical system, said system in particular comprising the above-described optical system. According to an example embodiment of the present invention, the optical system comprises at least
a. an image source which provides image content in the form of image data,
b. an image processing device for the image data,
c. a projector unit with a time-modulable light source for generating at least one light beam and with a drivable deflection device for the at least one light beam for scanning projection of the image content,
d. a first deflection unit onto which the image content is projected and which directs the projected image content onto a user's eye,
e. a second deflection unit arranged between the projector unit and first deflection unit and
f. an optical replication component which is arranged in a projection region of the first deflection unit.

According to an example embodiment of the present invention, in the method, the light beam, in particular the entire light beam, is deflected with the assistance of the second deflection unit via a first imaging path at a first point in time and via a second imaging path at a second point in time subsequent to the first point in time onto the at least one projection region of the first deflection unit. The projected image content is replicated with the assistance of the optical replication component and directed in spatially offset manner onto the user's eye, such that a plurality of exit pupils (A, A′, B, B′, C, C′, D, D′) which are arranged spatially offset from one another and including the image content are generated.

The optical system according to the present invention and the method according to the present invention are not here intended to be restricted to the above-described application and embodiments. In particular, to put into effect a mode of operation described herein, the optical system according to the present invention and the method according to the present invention may comprise a number of individual elements, components and units as well as method steps which differs from the number stated herein. In addition, the values located within the stated limits of the ranges of values disclosed herein are also deemed to be disclosed and usable as desired.

### BRIEF DESCRIPTION OF THE DRAWINGS

FIG. 1 shows a schematic representation of an optical system with a pair of data glasses, according to an example embodiment of the present invention.

FIG. 2 shows a first embodiment of an optical system for a virtual retinal display (retinal scan display), according to the present invention.

FIG. 3 shows a second embodiment of an optical system for a virtual retinal display (retinal scan display), according to the present invention.

FIG. 4 shows a third embodiment of an optical system for a virtual retinal display (retinal scan display), according to the present invention.

FIG. 5 shows a fourth embodiment of an optical system for a virtual retinal display (retinal scan display), according to the present invention.

FIG. 6 shows a schematic representation of a lens of the data glasses having a first deflection unit with an optical replication component of multilayer construction, according to an example embodiment of the present invention.

FIG. 7A is a schematic diagram of a first arrangement of individual exit pupils in an eye pupil area of the optical system, according to the present invention.

FIG. 7B is a schematic diagram of a second arrangement of individual exit pupils in a eye pupil area of the optical system, according to the present invention.

FIG. 8 shows a schematic representation of an effective total eyebox of the optical system, according to an example embodiment of the present invention.

FIG. 9 shows a method for projecting image content onto a user's retina with the assistance of an optical system, according to an example embodiment of the present invention.

### DETAILED DESCRIPTION OF EXAMPLE EMBODIMENTS

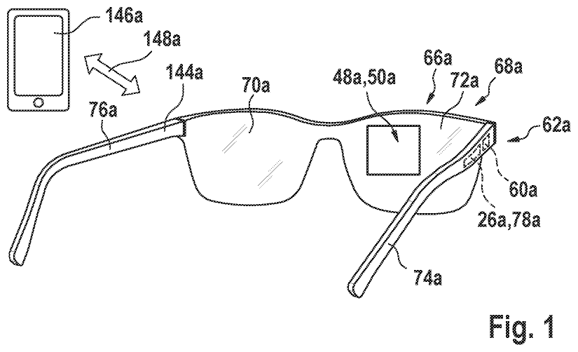

FIG. 1 shows a schematic representation of an optical system 68a with a pair of data glasses 66a. The data glasses 66a have lenses 70a, 72a. The lenses 70a, 72a are predominantly transparent. The data glasses 66a have a frame 144a with arms 74a, 76a. The data glasses 66a are part of the optical system 68a. In the case shown in FIG. 1, the optical system 68a comprises an external apparatus 146a. By way of example, the external apparatus 146a takes the form of a smartphone. The external apparatus 146a has a data communication link 148a with the data glasses 66a. Alternatively, the data glasses 66a may also completely form the optical system 68a. The optical system 68a is provided for forming a virtual retinal display. In the example shown in FIG. 1, the data glasses 66a have a computing unit 78a. The computing unit 78a is integrated into one of the arms 74a, 76a. Alternative arrangements of the computing unit 78a in the data glasses 66a, for example in a lens rim, are likewise possible. A “computing unit 78a” should in particular be taken to mean a controller with a processor, a memory unit, and/or operating, control and/or calculation software stored in the memory unit. The computing unit 78a is provided for operating the data glasses 66a, in particular individual components of the data glasses 66a.

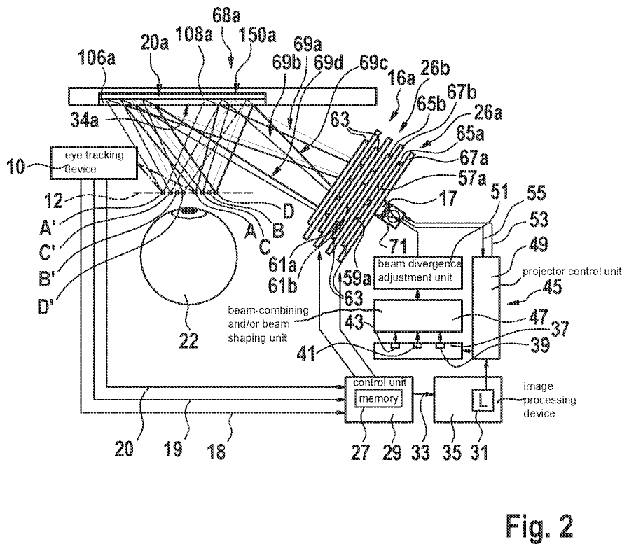

FIG. 2 shows a schematic representation of the optical system 68a. The optical system 68a has an image source. The image source provides image content 31 in the form of image data. The image source may be an integral part the data glasses 66a. Alternatively, the image source may also take the form of the external apparatus 146a or of part of the external apparatus 146a. The optical system 68a has an image processing device 35. The image processing device 35 is provided to digitally receive the image data and/or to directly generate the image data. The image processing device 35 is provided for digital image processing of the image data in order to generate subimage data which in particular represent modified image data. The image data may for example constitute a still image or a video feed. The image processing device 35 may in part be of one-piece construction with the computing unit 78a. The image processing device 35 is in this case set up to output the image data or the modified subimage data to a projector unit 45 of the optical system 68a.

The optical system 68a includes the projector unit 45. The projector unit 45 receives the image data or the subimage data from the image processing device 35. The projector unit 16a takes the form of a laser projector unit. The projector unit 45 is set up to emit the image data in the form of light beams 18. The light beams 18 take the form of scanned laser beams. Each time they pass through a scanning region of the projector unit 45, the scanned laser beams generate the reproduction associated with the image data. The projector unit 45 comprises a projector control unit 49. The projector unit 45 comprises a time-modulable light source 37. The time-modulable light source 37 is set up to generate the light beams 17. The projector control unit 45 is provided to open- or closed-loop control the generation and/or modulation of the light beams 17 by the light source 37. In the exemplary embodiment shown, the light source 37 comprises three (amplitude-modulable) laser diodes 39, 41, 43. A first laser diode 43 generates a red laser beam. A second laser diode 41 generates a green laser beam. A third laser diode 39 generates a blue laser beam. The projector unit 45 has a beam-combining and/or beam-shaping unit 47. The beam-combining and/or beam-shaping unit 47 is set up to combine, in particular mix, the differently colored laser beams from the laser diodes 39, 41, 43 to generate a color image. The beam-combining and/or beam-shaping unit 47 is set up to shape the light beam 17, in particular the laser beam, leaving the projector unit 45. Details regarding the formation of the beam-combining and/or beam-shaping unit 47 are assumed to be conventional in the related art. The projector unit 45 comprises a beam divergence adjustment unit 51. The beam divergence adjustment unit 51 is provided to adjust beam divergence of the light beam 17, in particular laser beam, leaving the projector unit 45, preferably to a path length, in particular dependent on an arrangement of optical elements of the optical system 68a, of the respective light beam 17 currently being emitted. The beam divergence of the light beams 17, in particular laser beams, leaving the projector unit 45 is preferably adjusted in such a manner that, after passing through the optical elements of the optical system 68a, a sufficiently small and sharp laser spot is obtained at the location where the beam impinges on the retina of a user's eye 22 of the virtual retinal display and the beam divergence at the location of an eye pupil area 54a of the optical system 68a in front of the user's eye 24a is at least substantially constant over the entire reproduction of the image data generated by the light beam 17, in particular the laser beam. Details regarding the formation of the beam divergence adjustment unit 51, for example by way of lenses with fixed and/or variable focal length, are assumed to be conventional in the related art. The projector unit 45 comprises at least one drivable deflection device 71. The drivable deflection device 71 takes the form of a MEMS mirror. The MEMS mirror is part of a micromirror actuator (not shown). The drivable deflection device 71 is set up for controlled deflection of the laser beam to generate a raster image. Details regarding the formation of the micromirror actuator are assumed to be conventional in the related art. The projector control unit 49 is set up for open- or closed-loop control of movement of the drivable deflection device 71 (see arrow 53). The drivable deflection device 71 regularly sends its current position signals back to the projector control unit 49a (see arrow 55).

The optical system 68a has a first deflection unit 20a. The image content 31 is projectable onto the first deflection unit 20a. The first deflection unit 20a is set up to direct the projected image content 31 onto the user's eye 22. The first deflection unit 20a forms a projection region 34a. Light beams 17 which impinge on the first deflection unit 20a within the projection region 34a are deflected/projected at least in part toward the user's eye 22. The first deflection unit 20a is set up to influence (refract, scatter and/or reflect) the light beams 17 in such a manner that at least some of the light beams 17, preferably at least one image generated from the image data, is imaged onto the eye pupil area 12 of optical system 68a, in particular onto the retina (not shown here) of the user's eye 22.

The optical system 68a furthermore has a second deflection unit 16a arranged between the projector unit 45 and first deflection unit 20a. This second deflection unit 16a serves to deflect the light beam 17, in particular the entire light beam 17, via a first imaging path 69a at a first point in time and via a second imaging path 69c at a second point in time subsequent to the first point in time onto the projection region 34a of the first deflection unit 20a. For this purpose, the second deflection unit 16a in this embodiment has a first deflection component 26a. The first deflection component 26a in turn has a first switchable λ/2 waveplate 67a and a first optical polarization grating 65a. In this embodiment, the first deflection component 26a takes the form of a first deflection stack in which the first switchable λ/2 waveplate 67a and the first optical polarization grating 65a are stacked on one another. The second deflection unit 16a furthermore has a second deflection component 26b. The second deflection unit 26b in turn has a second static λ/2 waveplate 67b and a second optical polarization grating 65b. The first switchable λ/2 waveplate serves to alter or maintain a polarization state, in particular a helicity, of the in this case circularly polarized light beam 17. The linearly polarized light (emitted by the light source 37) can be converted into circularly polarized light for example by using a linear polarizer (not shown here) and a λ/4 waveplate. Details in this respect are assumed to be conventional in the related art. The first optical polarization grating 65a is configured to deflect or diffract the circularly polarized light beam arriving from the switchable λ/2 waveplate 67a in a first deflection direction 57b as a function of the polarization state at the first point in time. At the second point in time, the polarization state of the circularly polarized light beam 17 changes by way of the switchable λ/2 waveplate 67a and the light beam is deflected or diffracted in a second deflection direction 59a by way of the first optical polarization grating 65a. The second static λ/2 waveplate 67b is configured to alter the polarization state of the light beam arriving from the first optical polarization grating 65a. The second optical polarization grating 65b in turn serves to deflect or diffract the light beam arriving from the second static λ/2 waveplate 67b toward the projection region 34a. The light beam 17 thus propagates with a slight angular and strong spatial offset relative to the light beam 17 irradiated into the second optical deflection unit 16a. In this embodiment, the second deflection unit 16a has two further downstream deflection components which are configured similarly to the first 26a or second 26b deflection components. Thus, in this embodiment, in addition to the first 69a and second imaging paths 69c, a third 69b and fourth imaging path 69d are generated or enabled which can be selected in temporal succession for projection of the light beam 17. The different imaging paths 69a to 69d enable the generation in temporal succession by way of the first deflection unit 18a of a plurality of exit pupils A, B, C and D which are arranged spatially offset from one another and include the respective image content 31. In particular, the exit pupils A, B, C and D may be generated in succession so rapidly that the user feels as if they were generated simultaneously.

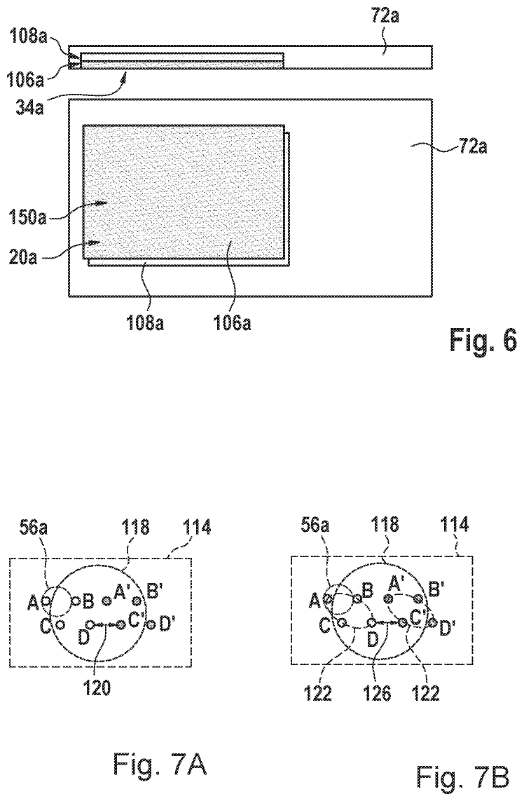

The optical system 68a furthermore has a replication component 150a which is arranged in the projection region 34a of the first deflection unit 20a and is set up to direct the projected image content 31 in replicated and spatially offset manner onto the user's eye 22, such that, in addition, a plurality of replicated exit pupils A′, B′, C′ and D′ which are arranged spatially offset from one another and include the respective image content 31 are generated. In the exemplary embodiment shown in FIG. 2, the optical replication component 150a is implemented in a multilayer structure with two holographically functionalized layers 106a, 108a. The optical replication component 150a comprises two lateral fully overlapping holographically functionalized layers 106a, 108a arranged in layers one behind the other. The layers 106a, 108a are here of uninterrupted planar configuration (cf. also FIG. 6). The optical replication component 150a is implemented in a multilayer structure with the at least two layers 106a, 108a, arranged one above the other, with different holographic functions, whereby the plurality of exit pupils A, A′, B, B′, C, C′, D, D′ which are arranged spatially offset from one another are generated. Part of each light beam 17 is here deflected at the first layer 106a while the remainder of the light beam 17 passes through the first layer 106a. A further part of the fraction of the light beam 17 which passes through the first layer 106a is deflected at the second layer 108a, while the remainder of the light beam 18a passes through the second layer 108a and the lens 72a in which the optical replication component 150a is integrated.

The image processing device 35 is set up to generate different subimage data for the at least two different imaging paths 69a-69d, such that any distortion (generated by optical elements of the optical system 68a) of the image content 31 over the respective imaging paths 69a-69d is at least partially compensated. The image processing device 35 is set up to generate subimage data which comprise subimages which are modified, in particular distorted, offset, rotated or otherwise scaled relative to the image data.

The optical system 68a has an eye tracking device 10. The eye tracking device 10 is integrated in one of arms 74a, 76a (cf. FIG. 1). Alternative arrangements of the eye tracking device 10 are possible. The eye tracking device 10 is set up to detect and/or determine a user's eye status. The eye tracking device 10 is set up to detect and/or determine an eye movement of the user. The eye tracking device 10 is set up to detect and/or determine an eye movement velocity of the user. The eye tracking device 10 is set up to detect and/or determine a pupil position of the user. The eye tracking device 10 is set up to detect and/or determine a pupil size of the user. The eye tracking device 10 is set up to detect and/or determine a gaze direction of the user. The eye tracking device 10 is set up to detect and/or determine an accommodation state of the user. The eye tracking device 10 is set up to detect and/or determine a fixation distance of the user. It is, of course, possible for the eye tracking device 10 to track and/or monitor only some of the above-stated parameters and/or for the eye tracking device to track and/or record still further parameters of the user or of the user's surroundings. In particular, dedicated sensor hardware may be provided for the eye tracking device 10 for detecting the accommodation state of the user's eyes 22 or a context-dependent assessment may be made which includes sensor data remote from the eyes, such as for example head posture, rate of rotation, acceleration, GPS data or also the currently displayed image content 31.

The optical system 68a includes the electronic control unit 29. The control unit 29 may in part be of one-piece construction with the computing unit 78a. The control unit 29 shown by way of example in FIG. 2 is provided for driving the image processing device 35. The control unit 29 is furthermore configured to drive the second deflection unit 16a in such a manner that the light beam 17 is deflected via the first imaging path at the first point in time 69a and via the second imaging path at the second point in time subsequent to the first point in time 69c onto the projection region 34a of the first deflection unit 20a. In this embodiment, the control unit 29 is configured to drive the second deflection unit 16a as a function of the eye status detected by way of the eye tracking device 10. In this connection, the control unit 29 additionally has a memory unit 27 on which are stored the positions associated with a respective imaging path 69a-69d of the exit pupils A, B, C, D, A′, B′, C′, D′ generated on the exit pupil plane 12 on an imaging path 69a-69d. The control unit 29 now checks whether the currently generated exit pupils A, B, C, D, A′, B′, C′, D′ result in an optimum eyebox for the user or whether, for example, ghosting or no images at all is/are currently occurring in the user's eye. If the control unit 29 identifies, for example, that ghosting is currently occurring, the control unit 29 accesses the memory unit 27 and drives the switchable λ/2 waveplate 67a of the second deflection unit 16a in such a manner that the light beam 17 is deflected via the second imaging path 69c at the second point in time subsequent to the first point in time as a function of the saved positions of the exit pupils A, B, C, D, A′, B′, C′, D′ and thus exactly one exit pupil A, B, C, D, A′, B′, C′, D′ is generated in the region of the user's pupil. The greatest anticipated pupil diameter is used as the basis here.

The image processing device 35 is set up, when generating the image data or subimage data, to take account of the user's eye status detected by the eye tracking device 10 in order to compensate fluctuations in the brightness of the perceived image caused thereby. The image processing device 35 is for this purpose set up, when generating the image data, to take account of which of the imaging paths 28a, 30a is currently selected in order to compensate fluctuations in the brightness of the perceived image caused thereby. The image processing device 35 is set up to modify a global brightness of all images entering the user's eye 22 at a point in time so dynamically that no fluctuations in brightness are perceived by the user when the user for example alters their pupil position and/or gaze direction.

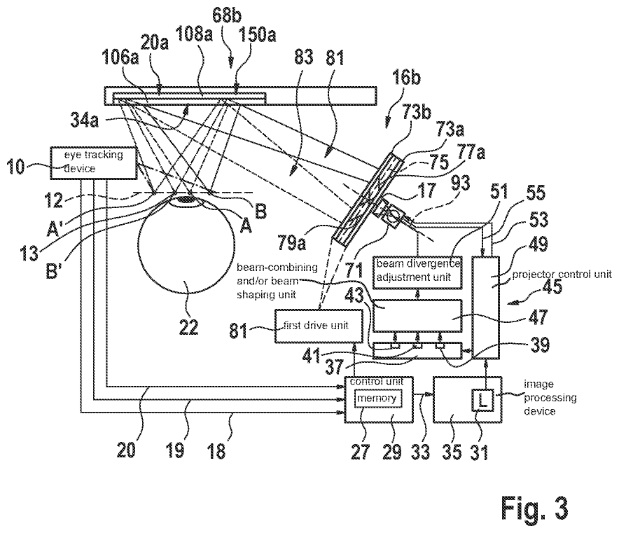

FIG. 3 is a schematic diagram of a second embodiment of an optical system 68b for a virtual retinal display (retinal scan display). In contrast with the first embodiment, the second deflection unit 16b has a third polarization grating 73a. The second deflection unit 16b additionally has a fourth polarization grating 73b and a third static λ/2 waveplate 75. In this embodiment, the third polarization grating 73b and the third static λ/2 waveplate 75 are arranged in a third deflection stack. The third polarization grating 73a serves to deflect or diffract the incident, circularly polarized light beam 17 in a third deflection direction 77a at a first point in time. The third static λ/2 waveplate 75 serves to alter a polarization state, in particular the helicity, of the light beam deflected by way of the third polarization grating 73a. The fourth polarization grating 73b in turn serves to deflect the light beam 17 arriving from the λ/2 waveplate 75 toward the projection region 34a. The second deflection unit 16b is rotatably mounted such that the light beam 17 is deflected in a fourth deflection direction 79a and onto the projection region 34a at a second point in time subsequent to the first point in time. In this embodiment, the second deflection unit 16b is mounted as a rotary holder or rotary tube. Rotation of the second deflection unit thus enables stepless, dynamic alteration or adjustment of the imaging paths. The diagram shows the generation of the first imaging path 81 at the first point in time and the generation of the second imaging path 83 at the second point in time. In this embodiment, the two imaging paths generate the plurality of exit pupils A, B, A′, B′.

In this embodiment, the control unit 29 is furthermore configured to drive a first drive unit 81 of the second deflection unit 16b as a function of the saved positions of the exit pupils and of the user's eye status. The first drive unit 81 is configured to generate the rotation of the second deflection unit 16b. In this embodiment, the first drive unit 81 takes the form of an actuator, in particular a piezo actuator.

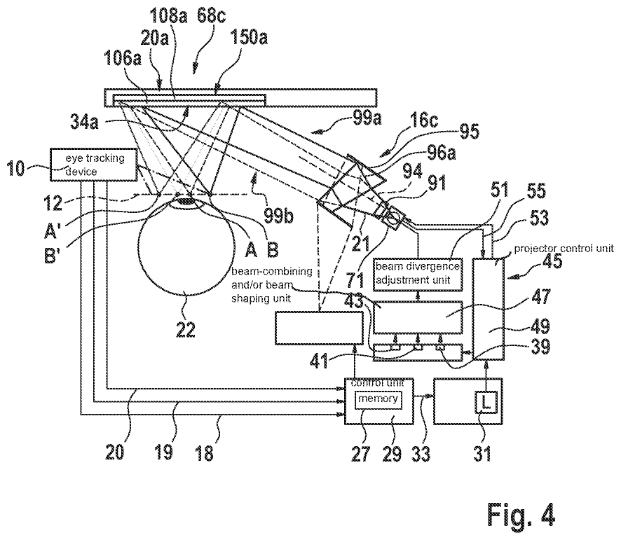

FIG. 4 is a schematic diagram of a third embodiment of an optical system 68c for a virtual retinal display (retinal scan display). In contrast with the above-described embodiments, the second deflection unit 16c takes the form of an optical prism, in particular a glass prism. The optical prism makes use of the refraction at the air-prism interface in order to deflect the incident, in particular linearly polarized, light beam 21 in a fifth deflection direction 96a at a first point in time. On exit from the prism, use is then made of the refraction at the prism-air interface to deflect the light beam 21 toward the projection region 34a. In this case too, the second deflection unit 16c is rotatably mounted such that the light beam 21 is deflected via a second imaging path 99b at a second point in time subsequent to the first point in time onto the projection region 34a. Rotation of the second deflection unit 16c thus here too enables stepless, dynamic alteration or adjustment of the imaging paths. The diagram shows the generation of the first imaging path 99a at the first point in time and the generation of the imaging path 99b at the second point in time. In this embodiment, the two imaging paths generate the plurality of exit pupils A, B, A′, B′.

In this embodiment, the control unit 29 is furthermore configured to drive a second drive unit 88 of the second deflection unit 16c as a function of the saved positions of the exit pupils and of the user's eye status. The second drive unit 88 is configured to generate the rotation of the second deflection unit 16c. In this embodiment, the second drive unit 88 takes the form of an actuator, in particular a piezo actuator.

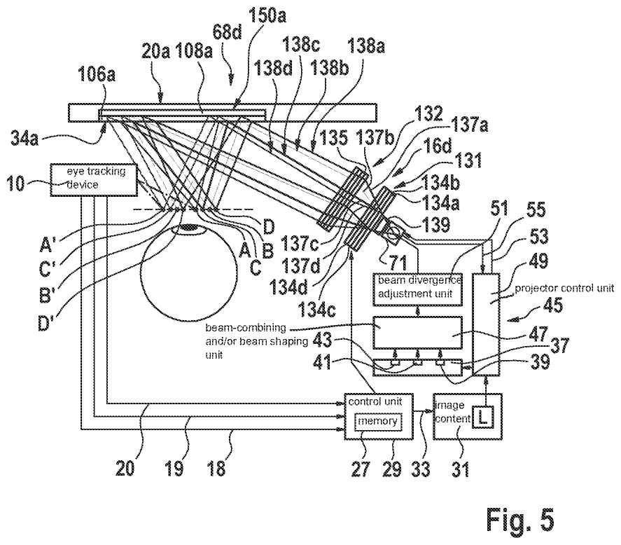

FIG. 5 is a schematic diagram of a fourth embodiment of an optical system 68d for a virtual retinal display (retinal scan display). In contrast with the above-described embodiments, the second deflection unit 16d here has four switchable transmissive holographic optical layers 134a to 134d which are arranged to form a first switchable HOE stack 131. The four switchable transmissive holographic optical layers here take the form of HOE layers. As a function of the switching state of the switchable transmissive holographic optical layers 134a to 134d, the incident light beam 139 is deflected in a first deflection direction 137a at the first point in time or in a second deflection direction 137b at the second point in time. In this exemplary embodiment, the incident light beam 139 has just one wavelength. The switchable transmissive holographic optical layers 134a to 134d are driven by the control unit 29. In this exemplary embodiment, the incident light beam is deflected in four different deflection directions 137a to 137d corresponding to the number of switchable transmissive holographic optical layers 134a to 134d. The second deflection unit 16d additionally has a second HOE stack 132 which comprises a second transmissive holographic optical layer 135. In this exemplary embodiment, the second HOE stack 132 has in total four transmissive holographic optical layers, each of which has a different incident angle-selective HOE function. The transmissive holographic optical layers of the second HOE stack 132 are not of switchable configuration. The four HOE layers of the second HOE stack 132 are configured to deflect the light beam arriving from the first stack 131 toward the projection region 34a as a function of the angle of incidence of the light beam on the first imaging path 138a or on the second imaging path 138b. In this exemplary embodiment, a total of four imaging paths 138a to 138d are provided corresponding to the number of HOE layers of the second HOE stack 132 and the number of deflection directions 137a to 137d.

FIG. 7A is a schematic diagram of a possible arrangement of exit pupils A, B, C, D, A′, B′, C′, D′ for the first embodiment of the optical system 68a in FIG. 2 and the fourth embodiment of the optical system 68d in FIG. 5. The generated exit pupils A, B, C, D, A′, B, C′, D′ are arranged substantially in a grid on an exit pupil plane 114 arranged. The spacing 120 between in each case two directly and/or diagonally adjacent exit pupils A, A′, B, B′, C, C′, D, D′ which are generated at different points in time is here smaller than the smallest anticipated pupil diameter 56a of the user. The intention is for exactly one exit pupil A, A′, B, B′, C, C′, D, D′ to be located in the region of the user's pupil at any one point in time. The greatest anticipated pupil diameter 118 is used as the basis for this purpose. In this case, the control unit 29 identifies by way of the eye tracking device 10 that the positions of exit pupils A or A′ and D or D′ at the point in time shown result in an optimum exit pupil, since no ghosting is generated here within the pupil diameter 118. In contrast, exit pupils B or B′ or C or C′ result in ghosting. Accordingly, if the imaging path is currently selected such that the exit pupils B or B′ or C or C′ are generated, the control unit 29 will drive the switchable λ/2 waveplate 67a of the second deflection unit 16a such that the imaging path associated with exit pupils A or A′ and D or D′ is selected at a subsequent point in time.

FIG. 7B is a schematic diagram of a possible arrangement of exit pupils A, B, A′, B′ for the second embodiment of the optical system 68b in FIG. 3 and the third embodiment of the optical system 68c in FIG. 4. The exit pupils A, A′, B, B′ generated at different points in time are arranged substantially on at least two identical geometrically closed curves 122 adjacently arranged on the exit pupil plane 114. The geometrically closed curves 122 here take the form of elliptical circular paths. The two elliptical circular paths do not overlap but are minimally spaced apart by the distance 126. The continuous stepless displacement or alteration of the position of the exit pupils on the elliptical circular paths enables a large number of possible positions of the exit pupil. The exit pupils A, B generated by way of the first deflection unit 20a are arranged on one of the two geometrically closed curves 122. The exit pupils A′, B′ generated by way of the optical replication component 150a are arranged on the second of the at least two geometrically closed curves 122. Here too, the intention is for exactly one exit pupil A, A′, B, B′ to be located in the region of the user's pupil at any one point in time. The greatest anticipated pupil diameter 118 is used as the basis for this purpose too. In this case, the control unit 29 identifies by way of the eye tracking device 10 that the positions of exit pupils A or A′ at the point in time shown result in an optimum exit pupil, since no ghosting is generated here within the pupil diameter 118. Exit pupils B or B′, in contrast, result in ghosting. If the imaging path is currently selected such that exit pupils B or B′ are generated, the control unit 29 will drive the drive units 81 or 88 of the second deflection unit 16c or 16c such that the imaging path associated with exit pupils A or A′ is selected at a subsequent point in time.

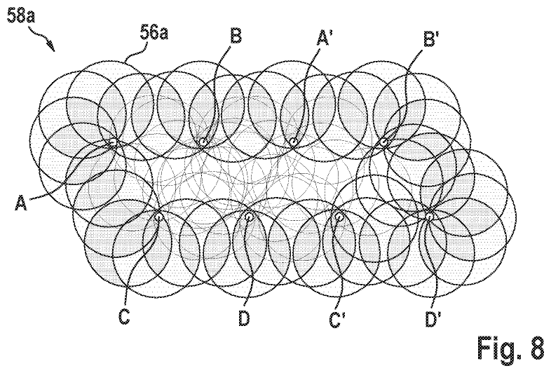

FIG. 8 is a schematic diagram of an effective total eyebox 58a of the optical system. The effective total eyebox 58a is obtained by covering an area composed of a grid of individual exit pupils A, A′, B, B′, C, C′, D, D′ spaced sufficiently closely together to ensure that, even in the case of a minimum pupil diameter 56a, light can be transmitted through the pupil of the user's eye 24a from at least one exit pupil A, A′, B, B′, C, C′, D, D′. This effective total eyebox requires a sufficiently fast change between the respective imaging paths switched in temporal succession so as to give the user the feeling that the exit pupils are generated simultaneously. An eye tracking device is not necessary for this purpose.

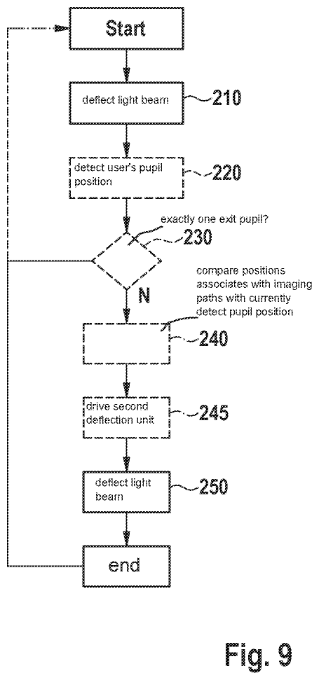

FIG. 9 shows, in the form of a flowchart, a method for projecting image content onto a user's retina with the assistance of an optical system. The optical system is in particular an optical system as shown in FIGS. 2 to 5. The optical system here comprises at least one image source which provides image content in the form of image data and an image processing device for the image data. The optical system additionally comprises a projector unit with a time-modulable light source for generating at least one light beam and with a drivable deflection device for the at least one light beam for scanning projection of the image content. The optical system moreover comprises a first deflection unit onto which the image content is projected and which directs the projected image content onto a user's eye. The optical system additionally has a second deflection unit arranged between the projector unit and first deflection unit and an optical replication component which is arranged in a projection region of the first deflection unit. In the method, the light beam, in particular the entire light beam, is firstly deflected in a method step 210 at a first point in time via a first imaging path with the assistance of the second deflection unit. In a method step 250 subsequent to method step 210, the light beam is deflected via a second imaging path at a second point in time subsequent to the first point in time onto the at least one projection region of the first deflection unit. The projected image content is here replicated with the assistance of the optical replication component and directed in spatially offset manner onto the user's eye such that a plurality of exit pupils which are arranged spatially offset from one another and include the image content are generated. The method is then terminated.

In an optional method step 220 subsequent to method step 210, the user's eye status, in particular the user's pupil position, is detected by way of an eye tracking device. In a subsequent method step 230, it is checked whether exactly one exit pupil is currently being generated in the region of the user's pupil. The greatest anticipated pupil diameter is used as the basis here. If it is established that exactly one exit pupil is currently being generated in the region of the user's pupil, the method is terminated or alternatively started from the beginning. If, however, it is established that ghosting or no exit pupil at all is currently located in the region of the user's pupil, in method step 240 a control unit compares the positions associated with a respective imaging path of the exit pupils generated on an imaging path on the exit pupil plane 12 with the currently detected pupil position. Thereupon, in a method step 245, the second deflection unit is driven by way of the control unit in such a manner that the light beam is deflected via the second imaging path at the second point in time subsequent to the first point in time in such a manner that exactly one exit pupil is generated in the region of the user's pupil.

1-24. (canceled)

25. An optical system for a virtual retinal display, comprising:
an image source which provides image content in the form of image data;
an image processing device for the image data;
a projector unit with a time-modulable light source configured to generate at least one light beam, and with a drivable deflection device for the at least one light beam for scanning projection of the image content;
a first deflection unit onto which the image content is projectable and which is configured to direct the projected image content onto a user's eye;
a second deflection unit, arranged between the projector unit and the first deflection unit, which is configured to deflect the entire light beam via a first imaging path at a first point in time and via a second imaging path at a second point in time subsequent to the first point in time onto at least one projection region of the first deflection unit; and
an optical replication component arranged in the at least one projection region of the first deflection unit and configured to direct the projected image content in replicated and spatially offset manner onto the user's eye, such that a plurality of exit pupils which are arranged spatially offset from one another and include the image content are generated.

26. The optical system as recited in claim 25, wherein the second deflection unit is configured to project the image content in the form of the light beam via the first imaging path at the first point in time and via the second imaging path at the second point in time subsequent to the first point in time onto the at least one projection region of the first deflection unit.

27. The optical system as recited in claim 25, wherein the second deflection unit has at least one first switchable transmissive holographic optical layer including a first switchable transmission HOE, the second deflection unit additionally having a second transmissive holographic optical layer including a second transmission HOE, the first switchable holographic optical layer being configured to diffract an incident light beam, as a function of a switching state of the first switchable transmissive holographic optical layer, in a first deflection direction at the first point in time or in a second deflection direction at the second point in time, the second transmissive holographic optical layer being configured to diffract, a light beam arriving from the first switchable holographic optical layer, as a function of an angle of incidence of the arriving light beam, toward the projection region.

28. The optical system as recited in claim 25, wherein the second deflection unit has a first deflection component having a first switchable λ/2 waveplate and a first optical polarization grating, the second deflection unit has a second deflection component, having a second static λ/2 waveplate and a second optical polarization grating, the first switchable λ/2 waveplate being configured to alter or maintain a polarization state including helicity, of an incident, circularly polarized light beam, the first optical polarization grating being configured to diffract, as a function of the polarization state, the circularly polarized light beam arriving from the switchable λ/2 waveplate in a first deflection direction, at the first point in time, or in a second deflection direction, at the second point in time, the second static λ/2 waveplate being configured to alter the polarization state of a light beam arriving from the first optical polarization grating, the second optical polarization grating being configured to diffract a light beam arriving from the second static λ/2 waveplate toward the projection region.

29. The optical system as recited in claim 25, wherein the second deflection unit has a third polarization grating, a fourth polarization grating, and a third static λ/2 waveplate, the third polarization grating being configured to diffract, an incident, circularly polarized light beam in a third deflection direction, the third static λ/2 waveplate being configured to alter a polarization state including a helicity, of the light beam diffracted using the third polarization grating, the fourth polarization grating being configured to diffract a light beam arriving from the third static λ/2 waveplate toward the projection region, the second deflection unit being rotatably mounted in such a manner that a light beam emitted from the second deflection unit is deflected onto the at least one projection region of the first deflection unit via the first imaging path at the first point in time and via the second imaging path at the second point in time subsequent to the first point in time.

30. The optical system as recited in claim 25, wherein the second deflection unit is in the form of at least one optical prism, the optical prism being rotatably mounted in such a manner that a light beam emitted from the optical prism is deflected onto the at least one projection region of the first deflection unit via the first imaging path at the first point in time and via the second imaging path at the second point in time subsequent to the first point in time.

31. The optical system as recited in claim 25, wherein the image processing device is configured to generate, using the image data from the image source, first subimage data at the first point in time and second subimage data at the second point in time to drive the projector unit, and wherein the image processing device is configured to generate different subimage data for the first and second imaging paths, such that any distortion of the image content over the respective imaging path is at least partially compensated.

32. The optical system as recited in claim 25, wherein the optical replication component is implemented in a multilayer structure with at least one holographically functionalized layer.

33. The optical system as recited in claim 32, wherein the optical replication component is implemented in the multilayer structure with at least two layers, arranged one above the other, with different holographic functions, whereby the plurality of exit pupils which are arranged spatially offset from one another are generated.

34. The optical system as recited in claim 32, wherein the optical replication component includes at least one layer in which at least two different holographic functions are implemented, and wherein the different holographic functions are formed in a common plane but in different intermittent zones of the at least one layer, whereby the plurality of exit pupils which are arranged spatially offset from one another are generated.

35. The optical system as recited in claim 25, wherein the second deflection unit and the optical replication component are configured such that the exit pupils generated using the second deflection unit and the optical replication component, at different points in time, are arranged substantially in a grid, a distance between in each case two directly and/or diagonally adjacent exit pupils which are generated, at different points in time, is smaller than a smallest anticipated pupil diameter of the user.

36. The optical system as recited in claim 29, wherein the second deflection unit and the optical replication component are configured such that the exit pupils which are generated using the second deflection unit and the optical replication component, at different points in time, are arranged substantially on and/or within at least two identical, geometrically closed curves including an elliptical circular path, arranged adjacently on an exit pupil plane.

37. The optical system as recited in claim 36, wherein the second deflection unit and the optical replication component are configured such that the exit pupils generated using the first deflection unit are arranged on and/or within a first one of the at least two geometrically closed curves, and the exit pupils generated using the optical replication component are arranged on and/or within a second one of the at least two geometrically closed curves.

38. The optical system as recited in claim 36, wherein the second deflection unit is rotatably mounted in such a manner that positions of the exit pupils on and/or within the at least two geometrically closed curves are adjustable, steplessly.

39. The optical system as recited in claim 25, wherein the second deflection unit and the optical replication component are configured such that each distance between two exit pupils generated on a common imaging path is greater than a greatest anticipated pupil diameter of the user.

40. The optical system as recited in claim 25, further comprising:
an eye tracking device configured to detect and/or determine a status of the user's eye, for detecting and/or determining eye movement of the eye, and/or eye movement velocity of the eye, and/or pupil position of the eye, and/or pupil size of the eye, and/or gaze direction of the eye, and/or accommodation state of the eye, and/or fixation distance of the eye.

41. The optical system as recited in claim 25, further comprising:
a control unit configured to drive the second deflection unit in such a manner that the light beam is deflected via the first imaging path at the first point in time and via the second imaging path at the second point in time subsequent to the first point in time onto at least one projection region of the first deflection unit.

42. The optical system as recited in claim 41, further comprising:
a memory unit on which are stored positions associated with a respective imaging path of the exit pupils generated on an imaging path on an exit pupil plane, the control unit being configured to drive the second deflection unit in such a manner that the light beam is deflected as a function of the stored positions of the exit pupils and of a user's eye status via the first imaging path at the first point in time and via the second imaging path at the second point in time subsequent to the first point in time such that exactly one exit pupil is generated in a region of the user's pupil, based on a greatest anticipated pupil diameter.

43. The optical system as recited in claim 25, wherein the image processing device is configured to, when generating the image data, take account of a detected eye status of the user and/or to take account of which imaging path is currently being used in order to compensate fluctuations in brightness of a perceived image caused thereby.

44. The optical system as recited in claim 25, wherein the image processing device is configured to, when generating the image data, take account of and compensate a user's visual impairment and/or defective accommodation.

45. The optical system as recited in claim 25, further comprising a pair of data glasses with a frame and lenses, wherein the at least one projector unit and the at least one second deflection unit are arranged on the frame, and wherein the at least one first deflection unit with the at least one optical replication component is integrated in at least one lens of the lenses.

46. The optical system as recited in claim 45, wherein the image source is arranged together with the image processing device in an external apparatus, and wherein the image data are transmitted from the external apparatus to the projector unit of the data glasses.

47. The optical system as recited in claim 45, wherein the image source is arranged in an external apparatus, wherein the image processing device is arranged together with the projector unit on the frame, and wherein the image data are transmitted from the external apparatus to the image processing device of the data glasses.

48. A method for projecting image content onto a user's retina using an optical system including:
an image source which provides image content in the form of image data,
an image processing device for the image data,
a projector unit with a time-modulable light source configured to generate at least one light beam and with a drivable deflection device for the at least one light beam for scanning projection of the image content,
a first deflection unit onto which the image content is projected and which directs the projected image content onto a user's eye,
a second deflection unit arranged between the projector unit and first deflection unit, and
an optical replication component which is arranged in a projection region of the first deflection unit,
the method comprising:
deflecting the entire light beam using the second deflection unit via a first imaging path at a first point in time and via a second imaging path at a second point in time subsequent to the first point in time onto the at least one projection region of the first deflection unit; and
replicating the projected image content using the optical replication component and directing the replicated image content in spatially offset manner onto the user's eye, such that a plurality of exit pupils which are arranged spatially offset from one another and include the image content are generated.
